(19) United States
(12) Patent Application Publication
(10) Pub. No.: US 2026/0021394 A1
(43) Pub. Date: Jan. 22, 2026

(54) ACQUISITION METHOD AND APPARATUS FOR VIRTUAL OBJECT, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Ziqi WEI, Shenzhen (CN)

(73) Assignee: Tencent Technology (Shenzhen) Company Limited, Shenzhen (CN)

(21) Appl. No.: 19/342,835

(22) Filed: Sep. 29, 2025

Related U.S. Application Data
(63) Continuation of application No. PCT/CN2024/119426, filed on Sep. 18, 2024.

(30) Foreign Application Priority Data
Dec. 29, 2023 (CN) 202311869501.9

(51) Int. Cl. A63F 13/537; A63F 13/79; G06F 3/04847

(52) U.S. Cl. CPC A63F 13/537; A63F 13/79; G06F 3/04847

(57) ABSTRACT

A method for acquiring a virtual object includes acquiring, in a target turn of a turn-based virtual task, account description information of a target account indicating task progress of the target account in the task; displaying at least one object acquisition control that corresponds to the account description information, wherein the object acquisition control is for acquiring a virtual object set including at least one virtual object having a common object attribute; displaying, in response to a trigger operation on a target object acquisition control, a target object set acquired based on the target object acquisition control; and displaying, in response to a selection operation on a target virtual object in the target object set, the target virtual object in a target region for displaying an interaction object set possessed by the target account, wherein interaction virtual objects are for performing an interaction operation in a virtual scene.

### CROSS-REFERENCE TO RELATED APPLICATIONS

This application is a continuation application of International Application No. PCT/CN2024/119426 filed on Sep. 18, 2024, which claims priority to Chinese Patent Application No. 202311869501.9 filed with the China National Intellectual Property Administration on Dec. 29, 2023, the disclosures of each being incorporated by reference herein in their entireties.

### FIELD

The disclosure relates to computer technologies, and more particularly to an acquisition method and apparatus for a virtual object, an electronic device, a computer-readable storage medium, and a computer program product.

### BACKGROUND

In various competitive game applications, one mode of acquiring virtual objects for game interaction is to randomly refresh a plurality of candidate virtual objects and then allow acquisition of at least one virtual object from the candidates by consuming virtual resources.

In some strategic game applications, different combinations of virtual objects may produce different effects, and a user may plan strategies for combining virtual objects during gameplay. However, because the refreshing of candidate virtual objects is highly random, it is difficult to acquire virtual objects that match the user's intended combination strategy. For example, a user may repeatedly attempt to obtain a particular combination, yet those combinations may be difficult to acquire. In addition, a server may continuously respond to switching instructions to load and release corresponding virtual objects, thereby consuming significant time and server resources.

To date, no effective solution has been provided for the foregoing problems.

### SUMMARY

Embodiments of this application provide an acquisition method and apparatus for a virtual object, an electronic device, a computer-readable storage medium, and a computer program product that can efficiently acquire combinations of particular virtual objects.

According to an aspect of the disclosure, a method for acquiring a virtual object, performed by an electronic device, includes acquiring, in a target turn of a turn-based virtual task, account description information of a target account, the account description information indicating task progress of the target account in the turn-based virtual task; displaying at least one object acquisition control that corresponds to the account description information, wherein an object acquisition control is for acquiring a virtual object set that may include at least one virtual object having a common object attribute; displaying, in response to a trigger operation on a target object acquisition control of the at least one object acquisition control, a target object set acquired based on the target object acquisition control; and displaying, in response to a selection operation on a target virtual object in the target object set, the target virtual object in a target region for displaying an interaction object set currently possessed by the target account, wherein interaction virtual objects in the interaction object set are for performing an interaction operation in a virtual scene.

According to an aspect of the disclosure, an acquisition apparatus for a virtual object includes at least one memory configured to store computer program code; and at least one processor configured to read the program code and operate as instructed by the program code, the program code including acquisition code configured to cause at least one of the at least one processor to acquire, in a target turn of a turn-based virtual task, account description information of a target account, the account description information indicating task progress of the target account in the turn-based virtual task; first display code configured to cause at least one of the at least one processor to display at least one object acquisition control that corresponds to the account description information, wherein an object acquisition control is for acquiring a virtual object set that may include at least one virtual object having a common object attribute; second display code configured to cause at least one of the at least one processor to display, in response to a trigger operation on a target object acquisition control of the at least one object acquisition control, a target object set acquired based on the target object acquisition control; and third display code configured to cause at least one of the at least one processor to display, in response to a selection operation on a target virtual object in the target object set, the target virtual object in a target region for displaying an interaction object set currently possessed by the target account, wherein interaction virtual objects in the interaction object set are for performing an interaction operation in a virtual scene.

According to an aspect of the disclosure, a non-transitory computer-readable storage medium, storing computer code which, when executed by at least one processor, causes the at least one processor to at least acquire, in a target turn of a turn-based virtual task, account description information of a target account, the account description information indicating task progress of the target account in the turn-based virtual task; display at least one object acquisition control that corresponds to the account description information, wherein an object acquisition control is for acquiring a virtual object set that may include at least one virtual object having a common object attribute; display, in response to a trigger operation on a target object acquisition control of the at least one object acquisition control, a target object set acquired based on the target object acquisition control; and display, in response to a selection operation on a target virtual object in the target object set, the target virtual object in a target region for displaying an interaction object set currently possessed by the target account, wherein interaction virtual objects in the interaction object set are for performing an interaction operation in a virtual scene.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a hardware environment of an exemplary acquisition method for a virtual object according to some embodiments.

FIG. 2 is a flowchart of an exemplary acquisition method for a virtual object according to some embodiments.

FIG. 3 is a schematic diagram of an exemplary acquisition method for a virtual object according to some embodiments.

FIG. 4 is a schematic diagram of another exemplary acquisition method for a virtual object according to some embodiments.

FIG. 5 is a schematic diagram of another exemplary acquisition method for a virtual object according to some embodiments.

FIG. 6 is a schematic diagram of another exemplary acquisition method for a virtual object according to some embodiments.

FIG. 7 is a schematic diagram of another exemplary acquisition method for a virtual object according to some embodiments.

FIG. 8 is a schematic diagram of another exemplary acquisition method for a virtual object according to some embodiments.

FIG. 9 is a schematic diagram of another exemplary acquisition method for a virtual object according to some embodiments.

FIG. 10 is a schematic diagram of another exemplary acquisition method for a virtual object according to some embodiments.

FIG. 11 is a flowchart of another exemplary acquisition method for a virtual object according to some embodiments.

FIG. 12 is a schematic structural diagram of an exemplary acquisition apparatus for a virtual object according to some embodiments.

FIG. 13 is a schematic structural diagram of an exemplary electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The terms “module[s]” or “unit[s]” may refer to hardware logic, a processor or processors executing computer software code, or a combination of both. The “modules” or “units” may also be implemented in software stored in a memory of a computer or a non-transitory computer-readable medium, where the instructions of each unit are executable by a processor to thereby cause the processor to perform the respective operations of the corresponding module or unit.

Each module or unit may exist respectively or be combined into one or more units. Some modules or units may be further split into multiple smaller function subunits, thereby implementing the same operations without affecting the technical effects of some embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

The terms “first,” “second,” and the like in the description, claims, and drawings are used to distinguish between similar elements and do not denote a particular order or priority. The described data or steps may be exchanged under appropriate circumstances so that the embodiments described herein may be implemented in an order different from that illustrated or described. The terms “include” and “have,” and variations thereof, are intended to denote non-exclusive inclusion (that is, elements, steps, or units not expressly listed may also be present).

During exemplary application of the related data acquisition processing in some embodiments, informed consent or independent consent of the subjects of personal information shall be obtained strictly in accordance with applicable laws and regulations, and subsequent data use and processing shall be performed within those laws and regulations and within the scope authorized by the subjects of the personal information.

In some embodiments, the term “module” or “unit” refers to a computer program having predetermined functions, or a part thereof, which operates with other relevant portions to achieve a predetermined objective, and may be implemented wholly or partly using software, hardware (such as a processing circuit or a memory), or a combination thereof. One processor (or multiple processors) and/or one memory (or multiple memories) may be configured to implement one or more modules or units. Each module or unit may be a portion of an overall module that provides the functions of the module or unit.

Before further describing some embodiments in detail, the following nouns and terms used in some embodiments are defined and apply to the explanations below.
1) A “virtual scene” is a scene, different from the real world, that is displayed (or provided) when an application program runs on a terminal device. The virtual scene may be a simulation of the real world, a semi-simulation and semi-fictional environment, or a completely fictional environment. It may be two-dimensional, 2.5-dimensional, or three-dimensional. For example, the virtual scene may include the sky, land, and ocean. The land may include environment elements such as a desert or a city, and a user may control a virtual object to move within the virtual scene.
2) A “virtual object” is a movable object in a virtual scene, such as a virtual person, a virtual animal, or an animated character. A virtual object may represent a user in the virtual scene or may be a character controlled via operations on a client. The virtual scene may include a plurality of virtual objects. Each virtual object has a shape and a volume in the virtual scene and occupies a portion of space therein.
3) A “turn-based virtual task” is a game mechanism designed in the virtual scene that allows a player to perform actions and make decisions according to a particular sequence and set of rules. Such a mechanism is commonly found in strategy games, role-playing games (RPGs), and certain simulation games.
4) “Account description information” refers to information that describes various data and states of a target account in a turn-based virtual task. The account description information includes, but is not limited to, at least one of the following: task progress, resource status, skill state, and achievement record of the account, and is intended to provide a way for a player to understand the player's game state.
5) “Object attributes” refer to features and parameters that a virtual object has in a virtual scene and that define the object's appearance, behavior, and interaction modes. In a turn-based virtual task, object attributes are key factors for distinguishing different virtual objects and form important bases for determining an object's role and characteristics in the game. Object attributes are a series of eigenvalues of the virtual object that determine its type, functions, capabilities, and interaction modes. Object attributes may include static attributes (such as name, appearance, or fixed capabilities) and dynamic attributes (such as current state, position, or health value).
6) “Resource indication information” is information presented on an object acquisition control and used to indicate the quantity of virtual resources to acquire a particular virtual object set. The resource indication information helps a player determine whether sufficient resources are available to acquire desired virtual objects and how acquisition will affect resource reserves. The resource indication information includes the type and quantity of resources and a quantity of such resources currently possessed by the player.
7) A “target account” refers to a player account that has a virtual object set and can participate in game interaction in a virtual game or a turn-based virtual task. The target account may be associated with personal data of a player and records the player's game progress, virtual object possession, and interaction history.
8) A “reference account” is a virtual account configured to interact with the target account in a turn-based virtual task. The reference account may be another player account, a non-player character (NPC) account controlled by a game system, or an account used for testing and simulation. The reference account may be configured in a card interaction scene.
9) “Cloud gaming,” also known as gaming on demand, refers to an approach in which a game program is deployed on a server and run there (a game instance). The game instance transmits game data output during execution to a browser page of a user terminal. The page invokes a media component of the browser to decode the game data and renders, based on the decoding result, a real-time game picture during gameplay. When the page detects a user operation in the game picture, it reports the operation to the game instance running on the server. Upon receiving game data generated by the game instance in response to the operation, the decoding and rendering process is repeated so that changes to the game picture based on the user's operation are presented on the page.

By way of example, cloud gaming is an online gaming technology based on cloud computing. It enables a thin client with relatively limited graphics processing and data computing capabilities to run high-quality games. In a cloud gaming scenario, the game does not run on the user terminal (such as a player's game terminal) but on a cloud server. The cloud server renders the game scene into audio and video streams and transmits the streams to the user terminal through a network. The user terminal may lack strong graphics and data processing capabilities but may provide basic streaming media playback, receive player input, and transmit that input to the cloud server.

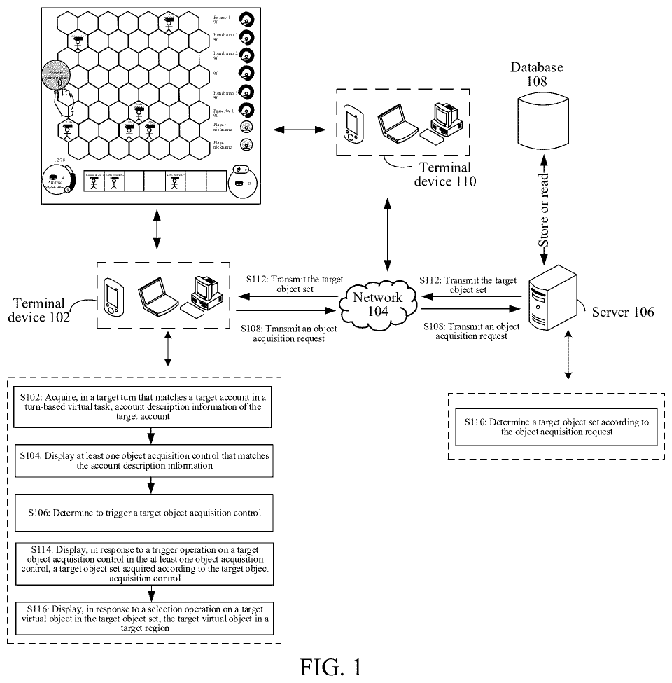

According to some embodiments, an acquisition method for a virtual object is provided. The method may be applied, for example, to an acquisition system for a virtual object in the hardware environment shown in FIG. 1. The acquisition system may include, but is not limited to, a terminal device 102, a network 104, a server 106, a database 108, and a terminal device 110. Corresponding clients (e.g., a game application client) run on terminal device 102 and terminal device 110, respectively. Each terminal device includes a human-computer interaction screen, a processor, and a memory. The screen displays a virtual game scene (as shown in FIG. 1) and provides a human-computer interaction interface to receive operations for controlling a virtual object in a virtual scene so that the virtual object can complete a game task set in the virtual scene. The processor generates an interaction instruction in response to the operation and transmits the instruction to the server. The memory stores related attribute data, such as object attribute information of the controlled virtual object and attribute information of possessed virtual props. The attribute information may include, but is not limited to, information identifying an identity and current position of a virtual prop. In one example, a client that controls a first virtual object through a first object account runs on terminal device 102, and a client that controls a second virtual object through a second object account runs on terminal device 110. The second virtual object and the first virtual object may be controlled in a game to perform particular interaction events, such as attack events, defense events, and skill-casting events. When the first object account and the second object account are accounts having a friend relationship, the first and second virtual objects may also execute cooperative adversarial events.

Server 106 includes a processing engine configured to perform storage and read operations on database 108. The processing engine reads, from database 108, virtual scene information for the virtual objects, object information for possessed virtual objects, and operation information performed by the object accounts.

Assuming terminal device 102 is logged in with a target account and terminal device 110 is logged in with a reference account having an adversarial relationship with the target account, then, in a turn-based virtual task, the target account and the reference account sequentially perform operations of virtual object acquisition and virtual object arrangement in their respective turns. The arranged virtual objects may spontaneously perform adversarial operations in a virtual game scene according to object positions and object attributes.

Some embodiments may be applied to an object acquisition stage in a target turn of the target account. An example process includes the following operations executed via terminal device 102 (logged in with a first account): at S102-S106, acquire, in a target turn corresponding to a target account in a turn-based virtual task, account description information of the target account, the account description information indicating task progress of the target account in the turn-based virtual task; display at least one object acquisition control corresponding to the account description information, the object acquisition control being configured to acquire a virtual object set that includes at least one virtual object sharing the same object attribute; and determine that a target object acquisition control is triggered.

Terminal device 102 then performs S108: transmit an object information acquisition request to server 106 through network 104. Server 106 performs S110: determine a target object set according to the object information acquisition request; and S112: transmit the target object set to terminal device 102 through network 104.

Terminal device 102 then performs S114 to S116: display, in response to the trigger operation on the target object acquisition control among the at least one object acquisition control, a target object set acquired according to the target object acquisition control; and, in response to a selection operation on a target virtual object in the target object set, display the target virtual object in a target region. The target region is configured to display an interaction object set currently possessed by the target account, and interaction virtual objects in the interaction object set are configured to perform an interaction operation in a virtual scene.

In some embodiments, when a terminal device of the same type as terminal device 102 has sufficient computing capability, operation S110 may be performed by that terminal device. This is one example and should not be considered limiting.

In some embodiments, the terminal device may be configured with a target client and may include, but is not limited to, at least one of the following: a mobile phone (such as an Android phone or an iOS phone), a laptop, a tablet computer, a personal digital assistant (PDA), a mobile Internet device (MID), a portable Apple device (PAD), a desktop computer, or a smart television. The target client may be a client that supports provision of a shooting game task, such as a video client, an instant messaging client, a browser client, or an education client. The network may include, but is not limited to, a wired network and a wireless network. The wired network may include a local area network, a metropolitan area network, and a wide area network. The wireless network may include Bluetooth, wireless fidelity (Wi-Fi), and other networks implementing wireless communication. The server may be a single server, a server cluster composed of a plurality of servers, or a cloud server. The above is merely an example and is not limiting.

In some embodiments, the acquisition method for a virtual object may be applied to a game terminal application (APP) that completes a given adversarial game task in a virtual scene, such as a virtual adversarial game application in a multiplayer online battle arena (MOBA) application. The adversarial game task may be a task in which a player uses a virtual object acquired via human-computer interaction to engage in adversarial interaction with a virtual object controlled by another player. The acquisition method for the virtual object may further be applied to a massively multiplayer online role-playing game (MMORPG) type terminal application. In this type of game, a current player may complete a social game task in a role-playing mode from a first-person viewing angle of a virtual object; for example, the player may complete a game task together with another virtual object. The acquisition method for the virtual object may further be applied to an auto battler (also known as auto chess) type game. The auto battler type game is a tactical strategy electronic game. A player places characters on a grid-shaped battlefield during a preparation stage, and the characters then automatically battle against each other. The player does not need to input further operations during battle. Some embodiments may also be applied, but are not limited, to an open world game. An open world means that a battle scene in the game is completely free and open, and a player may freely move to explore in any direction. The distance between boundaries in various directions may be large. Simulation objects of various shapes and sizes are provided in the scene and may generate various physical collisions or interactions with entities such as players and artificial intelligence (AI). In the open world game, the player may control a virtual object to complete a game task through adversarial interaction.

Game tasks in the above types of games may also run in applications (such as non-standalone game APPs) in the form of plug-ins or applets, or may run in standalone game APPs in game engines. The types of such game applications may include, but are not limited to, at least one of the following: two-dimensional (2D) game applications, three-dimensional (3D) game applications, virtual reality (VR) game applications, augmented reality (AR) game applications, and mixed reality (MR) game applications. The above is merely an example and is not limiting.

A solution for collaborative implementation of the terminal device and the server involves two game modes, for example, a local game mode and a cloud gaming mode. The local game mode means that the terminal device and the server cooperatively run the game processing logic. Operation instructions input into the terminal device by a player are partly processed by the game logic run by the terminal device and partly processed by the game logic run by the server. The game logic processed by the server may be more complex and consume more computing power. The cloud gaming mode means that game logic processing is completely performed by the server (such as a cloud server). The cloud server renders game scene data into audio and video streams and transmits the streams to the terminal device through a network for display. For example, the terminal device may have basic streaming media playback capability and the ability to acquire operation instructions input by the player and transmit the instructions to the server.

In some embodiments, at least one object acquisition control corresponding to the account description information is determined according to the account description information that indicates task progress of the target account in the virtual task, and each object acquisition control may be configured to acquire a plurality of virtual objects sharing the same object attribute. When a target object acquisition control is determined from among a plurality of object acquisition controls, a target object set acquired according to the target object acquisition control is displayed. A probability of acquiring particular virtual objects may be increased through an association relationship between object attributes and the object acquisition controls. Combinations of particular virtual objects are then acquired over multiple object acquisition operations in the turn-based virtual task, thereby efficiently obtaining such combinations and reducing the difficulty of acquisition. Because the user can quickly determine combinations of particular virtual objects, repeated switching to acquire those objects is avoided, and server resources otherwise consumed by repeatedly responding to switching operations are saved.

In some embodiments, the displayed object acquisition control may be determined according to the account description information that indicates task progress of the target account in the virtual task, so that different object acquisition controls may be displayed at different stages for the target account. This enables the user to choose virtual objects with different attributes at different stages, thereby improving the flexibility of combining virtual objects.

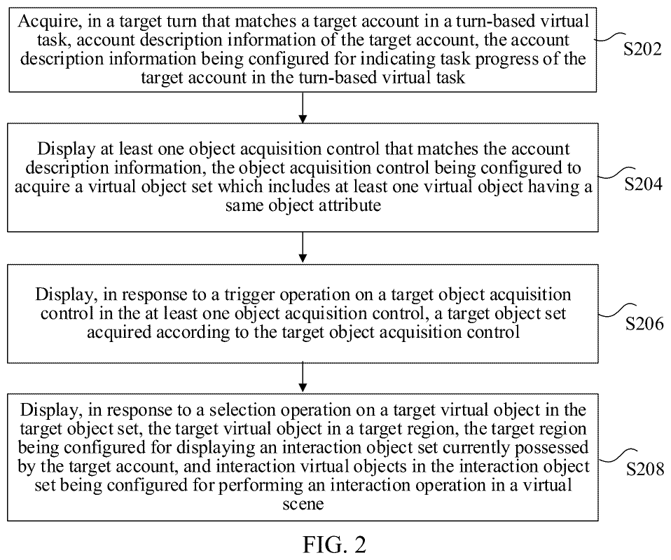

In some embodiments, as shown in FIG. 2, the acquisition method for the virtual object includes the following operations:
S202: Acquire, in a target turn that corresponds to a target account in a turn-based virtual task, account description information of the target account, the account description information being configured to indicate task progress of the target account in the turn-based virtual task.
S204: Display at least one object acquisition control that corresponds to the account description information, the object acquisition control being configured to acquire a virtual object set that includes at least one virtual object sharing the same object attribute.
S206: Display, in response to a trigger operation on a target object acquisition control among the at least one object acquisition control, a target object set acquired according to the target object acquisition control.
S208: Display, in response to a selection operation on a target virtual object in the target object set, the target virtual object in a target region, the target region being configured to display an interaction object set currently possessed by the target account, where interaction virtual objects in the interaction object set are configured to perform an interaction operation in a virtual scene.

The acquisition method for the virtual object provided in some embodiments may be applied to, but is not limited to, a game application that provides selectable virtual objects for an object account. The game application may include, but is not limited to, an MOBA game application, an MMORPG game application, or an auto battler game application. The application scenarios for acquiring virtual objects are not limited. A game application of this type may include a plurality of interaction turns. Object accounts performing interaction tasks may acquire respective virtual objects in their respective turns through operations S202 to S208 and perform interaction operations with the acquired virtual objects. An attack operation may be performed between virtual objects possessed by object accounts having an adversarial relationship. A mutual assistance operation may be performed between virtual objects possessed by object accounts having a teammate relationship.

The content of the task of the auto battler game is described below. In an auto battler game application, the game task may be a collectible hero card multiplayer turn-based competitive task. N players participate in the game and perform battles in pairs in sequence. Each player occupies one virtual battle site, and the sites of two players battling are spliced together in a battle stage to perform the battle on the combined virtual battle site. Each game task includes multiple turns. Each turn includes two stages, for example, a preparation stage and a battle stage. In the preparation stage, a player purchases game pieces (e.g., virtual objects) in a shop and arranges formations on a chessboard. In the battle stage, the lineups of both opposing parties are locked, and the game pieces automatically battle until all pieces of one party are defeated. The party having with all pieces defeated is the loser of that turn, and a health value (a battle resource) is deducted from the loser. After the virtual task between the two object accounts ends, new opponents are matched for each player, and a player is eliminated when the health value is reduced to below zero. The last remaining player wins the game (first place).

In operation S202, the target turn corresponding to the target account may be a stage in which the target account is allowed to perform operations of acquiring and deploying virtual objects in the virtual site. Operations S202 to S208 may thus be applied to a virtual object acquisition stage.

The account description information of the target account in operation S202 may include parameter information configured to indicate task progress of the target account in the turn-based virtual task. For example, the account description information may include, but is not limited to, an account level of the target account, a quantity of virtual resources possessed by the target account, a virtual experience value accumulated by the target account through interaction operations in the virtual task, and a turn sequence number of the target turn of the target account. The content of the account description information is not limited.

In some embodiments, after the account description information is acquired through operation S202, an object acquisition control that corresponds to the account description information may be displayed through operation S204. There may be one or more object acquisition controls in operation S204. A matching relationship between the account description information and the object acquisition control may include, but is not limited to, matching the account description information with a type of object acquisition control or matching the account description information with a quantity of object acquisition controls. In some embodiments, different account description information may correspond to different control types and control quantities of the displayed object acquisition controls.

The object acquisition control may be configured to acquire a virtual object set composed of at least one virtual object having the same object attribute. The object attribute of the virtual object may indicate an object characteristic. For example, the object attribute may be an object level, indicating the strength of the virtual object in an interaction operation. The object attribute may further be an object type, such as a warrior type or a shooter type, indicating an operational characteristic of the virtual object in an interaction operation. For example, a warrior-type virtual object may have high defense capability, while a shooter-type virtual object may have a long attack distance. In some embodiments, the content of the object attribute is not limited.

With reference to operations S202 and S204, when the target account is in different stages of task progress, different object acquisition controls may be displayed accordingly. This allows the target account to acquire virtual objects with different characteristics and form particular virtual object combinations.

Several exemplary combination modes of the account description information and the object attributes are described below.

In a case that the account description information is the account level of the target account and the object attribute is the object level of the virtual object, the account level may accumulate an operation experience value according to task operations of the target account in the turn-based virtual task, and the level is updated according to the accumulated operation experience value. The object level may indicate the operational strength of the virtual object in an interaction operation. The operational strength may include one or more of an attribute value, an attack force value, and a defense force value. At an early stage of task progress, the target account may choose to acquire a large number of low-level virtual objects and form particular combinations with them to win the game quickly. Alternatively, the target account may conserve opportunities early and later acquire high-level virtual objects. Although disadvantaged early due to a lack of strong combinations, the target account may acquire high-level virtual objects later using accumulated resources and win through high-level combinations formed in the late stage.

In a case that the account description information is the account level of the target account and the object attribute is the object type of the virtual object, the object type may indicate operational characteristics of the virtual object in an interaction operation. For example, a virtual object with a “water” attribute may restrain a virtual object with a “fire” attribute.

In some embodiments, when the account description information is the account level of the target account and the object attribute of the virtual object is the object type, if an opponent account possesses a first-type virtual object in a first stage, a plurality of second-type virtual objects may be acquired and combined into a second-type virtual object set, where the second-type virtual objects are configured to restrain the first-type virtual object. If, in a second stage, the opponent account possesses a third-type virtual object, a fourth-type virtual object configured to restrain the third-type virtual object may be acquired to form a virtual object set.

For example, in an early stage (first stage) of task progress, if an opponent account possesses a “fire” attribute virtual object (first type), the target account may acquire a large number of “water” attribute virtual objects (second type) to quickly form a particular “water” attribute combination that restrains the opponent's “fire” attribute objects. In a later stage (second stage) of task progress, the target account may select a target object set having a particular object attribute, based on an increased number of acquisition controls and the opponent's currently possessed objects, to counter the opponent.

The above combination modes are examples and are not intended to limit actual combination modes.

In some embodiments, when exemplary object acquisition controls are displayed through operations S202 and S204, the target account may, through operations S206 and S208, display the virtual objects in the target object set corresponding to the selected target object acquisition controls and, in response to a selection operation, configure the selected target virtual objects in an interaction object set possessed by the target account, so that the target account may arrange and control the target virtual objects to perform subsequent interaction operations.

The trigger operation on the target object acquisition control may include, but is not limited to, a click operation, a double-click operation, or a long press performed on a control identifier of the target object acquisition control. In some embodiments, the selection operation on the target virtual object may include, but is not limited to, a click operation, a double-click operation, or a long press performed on an object identifier of the target virtual object. The types of selection and trigger operations are not limited.

Modes of interaction for target virtual objects in the target region across multiple games are described below.

For example, in an MOBA game application, a plurality of object acquisition controls may be displayed at a particular stage according to a character level of a current virtual character controlled by the target account. When target virtual objects (which may be virtual prop objects) are selected from the target object set corresponding to the selected target object acquisition control, the acquired target virtual objects are configured for the virtual characters, enabling the virtual characters to perform competitive interactions in a virtual scene. Correspondingly, the target region may be a virtual prop bar displaying the virtual characters controlled by the target account.

For another example, in an MMORPG game application, each object account controls one virtual character to perform competitive interactions in a virtual scene. At a particular stage, a plurality of object acquisition controls may be displayed according to the character level of the current virtual character controlled by the target account. When target virtual objects (which may be virtual prop objects) are selected from the target object set corresponding to the selected target object acquisition control, the acquired target virtual objects are equipped on the virtual characters, enabling them to perform competitive interactions in a virtual scene. Correspondingly, the target region may be a virtual backpack displaying the virtual character controlled by the target account. The virtual backpack may display virtual props currently possessed by the character, such as a weapon, a helmet, or armor.

For another example, in an auto battler game application, object accounts may obtain at least one virtual object (which may be a virtual game piece) through operations S202 to S208. Correspondingly, the target region may be a battle preparation region displaying the virtual objects possessed by the target account in a waiting state. The virtual scene may further include a battle region where the virtual objects engage in battle autonomously, without direct interference by the target account. The virtual interaction operations may include, but are not limited to, attack operations, defense operations, and skill-casting operations.

In some embodiments, at least one object acquisition control corresponding to the account description information is determined according to the account description information that indicates task progress of the target account in the virtual task, and each object acquisition control may be configured to acquire a plurality of virtual objects sharing the same object attribute. When a target object acquisition control is determined from among a plurality of object acquisition controls, a target object set acquired according to the target object acquisition control is displayed. A probability of acquiring particular virtual objects may be increased through an association relationship between object attributes and object acquisition controls. Combinations of particular virtual objects are then acquired over multiple object acquisition operations in the turn-based virtual task, thereby efficiently obtaining such combinations and reducing the difficulty of acquisition. Because the user can quickly determine combinations of particular virtual objects, repeated switching to acquire those objects is avoided, and server resources otherwise consumed by repeatedly responding to switching operations are saved.

In some embodiments, the displayed object acquisition control may be determined according to the account description information that indicates task progress of the target account in the virtual task, so that different object acquisition controls may be displayed at different stages for the target account. This enables the user to choose virtual objects with different attributes at different stages, thereby improving the flexibility of combining virtual objects.

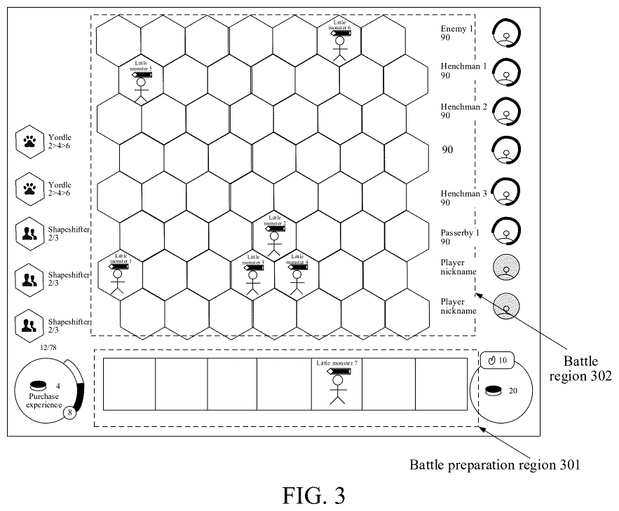

The game task in an auto battler game application is described below with reference to FIG. 3. As shown in FIG. 3, a current interaction interface on a client logged in by a target account is displayed. A battle preparation region 301 is shown as the target region. A “little monster 7” in the region is a virtual object currently possessed by the target account and in a waiting state. “Little monster 1,” “little monster 2,” “little monster 3,” and “little monster 4” in battle preparation region 302 are virtual objects currently possessed by the target account and selected to participate in a virtual adversarial interaction. “Little monster 5” and “little monster 6” shown in FIG. 3 are virtual objects selected by an opponent account to participate in a virtual object interaction. In the preparation stage of a battle turn, the target account and the opponent account may acquire virtual objects through operations S202 to S208, select the virtual objects participating in battle, increase their levels, and arrange their positions. In the battle stage, the virtual objects placed on the chessboard shown in FIG. 3 automatically engage in battle. After multiple turns, when all virtual objects of one party are defeated, the result of that turn is determined.

In some embodiments, during the object acquisition stage, displaying, in response to a trigger operation on a target object acquisition control among the at least one object acquisition control, a target object set acquired according to the target object acquisition control includes:
S1: Consuming, in response to the trigger operation on the target object acquisition control, a target quantity of virtual resources from a virtual resource set currently possessed by the target account, when target resource indication information is displayed on the target object acquisition control. Each object acquisition control displays resource indication information, and the resource indication information indicates the virtual resources to be consumed for acquiring a corresponding virtual object set.
S2: Acquiring the target object set corresponding to the target object acquisition control, where the virtual objects in the virtual object set corresponding to one object acquisition control share the same object level, an object level of candidate virtual objects in the target object set is a target level, and an object attribute includes the object level.
S3: Displaying the candidate virtual objects included in the target object set.

In some embodiments, resource indication information may also be displayed on the at least one object acquisition control displayed in operation S204 to indicate the virtual resources to be consumed when acquiring the virtual object set through a corresponding object acquisition control. The virtual resource may be a resource acquired by the target account by performing an interaction task in the turn-based virtual task, such as a virtual empirical value or virtual gold coins, and may not be exchangeable for real-world currency. The type of the virtual resource is not limited in some embodiments.

In some embodiments, the object attribute in operation S204 may be an object level. Different resource indication information may be configured and displayed for different object acquisition controls. When different object acquisition controls are configured to acquire candidate virtual objects with different object levels, the resource indication information displayed on the object acquisition controls may indicate that different quantities of virtual resources are consumed to display a plurality of candidate virtual objects having different object levels.

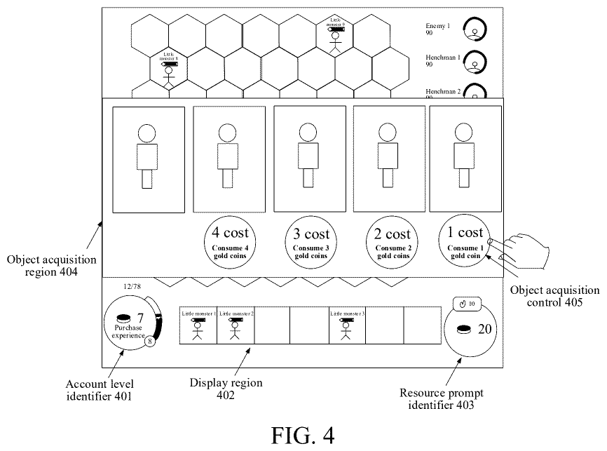

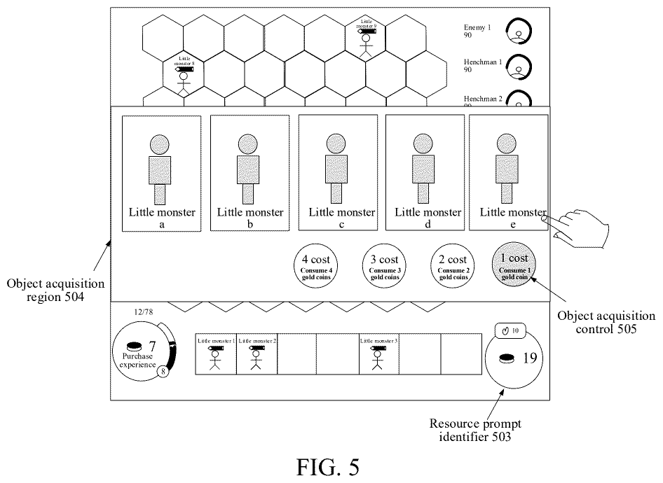

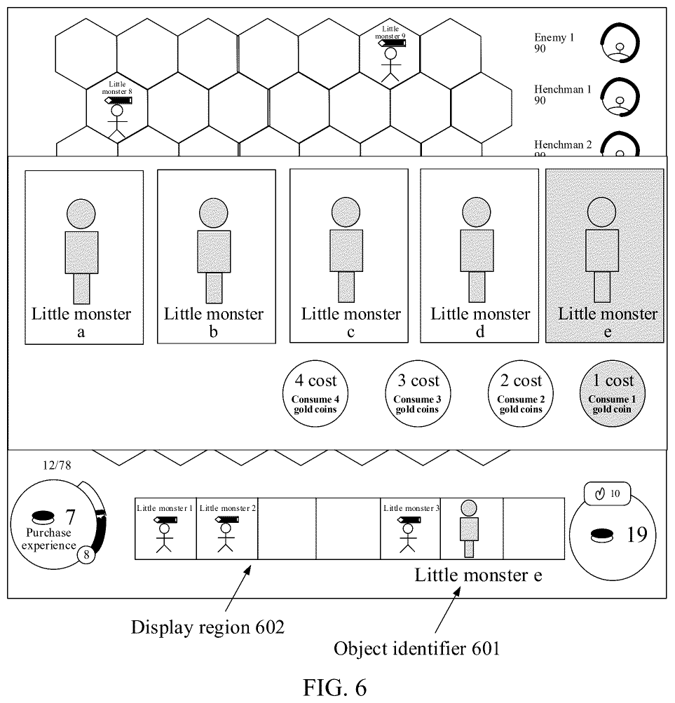

The above implementation is described below with reference to FIG. 4, FIG. 5, and FIG. 6. As shown in FIG. 4, in an object acquisition stage in a current turn of a target account, an application interface, as shown in FIG. 4, may be displayed. In FIG. 4, an account level identifier 401 is displayed, indicating the target account's current level is “7”. In some embodiments, the account level may be increased by consuming virtual resources.

In some embodiments, a display region 402 is also displayed on the interface, indicating an interaction virtual object currently possessed by the target account, and a plurality of virtual objects waiting to perform a virtual interaction operation are displayed therein.

The interface further displays a resource prompt identifier 403, indicating that the virtual resource (virtual gold coins) currently possessed by the target account is “20”.

The interface also displays an object acquisition region 404 with a plurality of object acquisition controls configured to acquire a virtual object set. The plurality of object acquisition controls includes an object acquisition control 405. For example, a plurality of object display regions are shown in the object acquisition region 404, and these regions may be displayed in an empty state (represented as a blank line drawing in FIG. 4) to indicate that the virtual object set has not yet been acquired by refreshing.

The plurality of object acquisition controls displayed in the object acquisition region 404 display corresponding resource indication information. For example, “1 cost; consume 1 gold coin” displayed on object acquisition control 405 indicates that a virtual object set with an object level of “1 cost” may be acquired by consuming 1 gold coin. Correspondingly, the resource indication information displayed on other object acquisition controls in the object acquisition region 404 indicates the following: a virtual object set with an object level of “2 cost” may be acquired by consuming 2 gold coins; a virtual object set with an object level of “3 cost” may be acquired by consuming 3 gold coins; and a virtual object set with an object level of “4 cost” may be acquired by consuming 4 gold coins.

As shown in FIG. 4, in response to the triggering of object acquisition control 405, the interface switches to the display shown in FIG. 5. In FIG. 5, an object acquisition region 504, an object acquisition control 505, and a resource prompt identifier 503 are updated. A target object set is acquired according to object acquisition control 505, and the five candidate virtual objects included in the target object set (displayed as grayscale legends in object acquisition region 504) are displayed in the object acquisition region 504. These include “little monster a,” “little monster b,” “little monster c,” “little monster d,” and “little monster e.” The object acquisition control 505 may be highlighted to indicate that the object level of the currently acquired virtual object in the object set is “1 cost” and that 1 gold coin has been consumed. Correspondingly, the resource prompt identifier 503 is updated to display that the quantity of virtual gold coins currently possessed by the target account is “19”.

In some embodiments, upon a selection operation on “little monster e,” the interface switches to the display shown in FIG. 6. In FIG. 6, the object display region corresponding to “little monster e” is shown in grayscale in the object acquisition region to indicate that this target virtual object has been acquired. An object identifier 601 corresponding to “little monster e” is displayed in a display region 602 to indicate that the target account now possesses the target virtual object “little monster e”.

In the implementation described above, the virtual resource is consumed to reveal the candidate virtual objects, but no additional resources are consumed when one is selected. In some alternative embodiments, virtual resources currently possessed by the target account may also be consumed upon the selection operation on “little monster e” in FIG. 5 to acquire the target virtual object “little monster e”.

Through some embodiments, when target resource indication information is displayed on the target object acquisition control, a target quantity of virtual resources is consumed from the virtual resource set currently possessed by the target account in response to a trigger operation on that control. A target object set corresponding to the target object acquisition control is then acquired. This allows for the display of multiple object acquisition controls that indicate different virtual resource costs. The target account can acquire virtual objects with different levels by consuming the corresponding virtual resources, allowing a user to balance resource consumption with desired virtual objects based on the association between object levels and acquisition controls, thereby increasing the probability of acquiring particular virtual objects. Combinations of particular virtual objects can thus be acquired over multiple object acquisition operations in the turn-based virtual task, efficiently obtaining such combinations and reducing the difficulty of acquisition.

In some embodiments, the step of displaying at least one object acquisition control that corresponds to the account description information includes:
S1: Display a first object acquisition control according to a target style when a resource quantity of the virtual resources currently possessed by the target account is less than a first quantity indicated by first resource indication information, the first resource indication information being displayed on the first object acquisition control.
S2: Display operation prompt information in response to a trigger operation on the first object acquisition control, the operation prompt information indicating that a virtual object set corresponding to the first object acquisition control may not be acquired at that time.

In some embodiments, when the quantity of virtual resources currently possessed by the target account is less than or equal to the resource quantity corresponding to the first object acquisition control in the plurality of object acquisition controls, the first object acquisition control may be displayed in a preset style to indicate that it may not currently be triggered. The preset style may include at least one of the following: a preset control color, a preset control shape, or a preset control size. For example, the first object acquisition control may be displayed in grayscale to indicate that it cannot be triggered.

In the above implementation, when the first object acquisition control is displayed in grayscale, a click operation on the first object acquisition control may cause the operation prompt information to be displayed, indicating that the virtual object set cannot currently be acquired through that control.

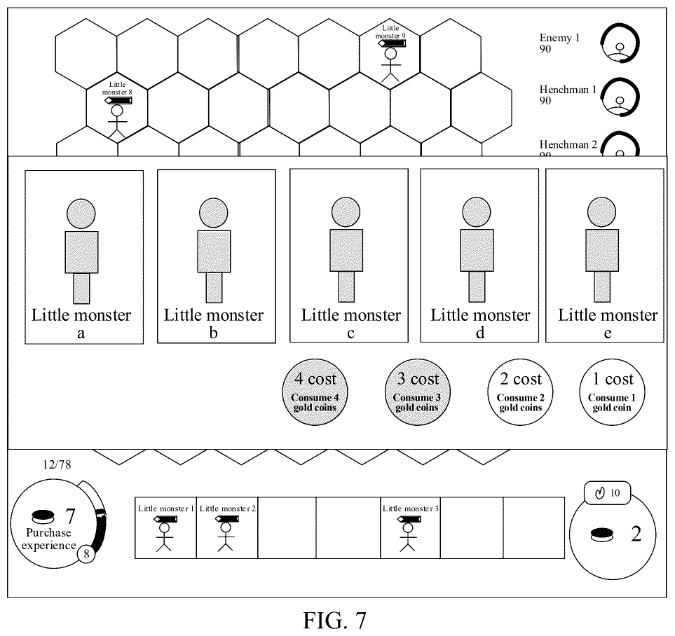

For example, in FIG. 7, assuming that the quantity of virtual gold coins currently possessed by the target account is 2, object acquisition controls that may be triggered by the target account are the “1 cost” and “2 cost” controls, while the “3 cost” and “4 cost” controls may not be triggered. The “3 cost” and “4 cost” object acquisition controls are displayed in grayscale to indicate that a virtual object set of “3 cost” or “4 cost” cannot be acquired through those controls.

In some embodiments, when the quantity of virtual resources currently possessed by the target account is less than the first quantity indicated by the first resource indication information, the first object acquisition control is displayed in the target style; and in response to a trigger operation on the first object acquisition control, the operation prompt information is displayed. This efficiently indicates the triggerable state of the object acquisition controls, thereby improving display efficiency.

In some embodiments, after displaying, in response to a trigger operation on a target object acquisition control among the at least one object acquisition control, a target object set acquired according to the target object acquisition control, the method further includes:
S1: Consume, in response to a trigger operation on a reference object acquisition control, a reference quantity of virtual resources from the virtual resource set currently possessed by the target account;
S2: Acquire a reference object set corresponding to the reference object acquisition control, with the object level of candidate virtual objects in the reference object set being a reference level;
S3: Update the target object set according to the reference object set; and
S4: Display the candidate virtual objects included in the updated target object set.

In some embodiments, a virtual resource set possessed by each account is recorded.

In some embodiments, after the target object set is acquired and displayed, in response to a trigger operation on the reference object acquisition control, a corresponding virtual resource is consumed, and the displayed target object set is updated according to the reference object set acquired based on the reference object acquisition control.

In some embodiments, the reference object acquisition control and the target object acquisition control may be the same control or different controls. When the reference object acquisition control is different from the target object acquisition control, the reference quantity of virtual resources consumed by triggering the reference object acquisition control may differ from the target quantity of virtual resources consumed by triggering the target object acquisition control. Correspondingly, the object level of the virtual objects in the reference object set may differ from that of the virtual objects in the target object set.

In some embodiments, in response to a trigger operation on the reference object acquisition control, the reference quantity of virtual resources is consumed from the virtual resource set currently possessed by the target account; the reference object set corresponding to the reference object acquisition control is acquired; the target object set is updated according to the reference object set; and the candidate virtual objects included in the updated target object set are displayed. After the target object set is acquired by the target account based on the target object acquisition control, a corresponding quantity of virtual resources may further be consumed according to the reference object acquisition control, and the acquired target object set is updated, to increase the probability that the target account acquires particular virtual objects.

In some embodiments, updating the target object set according to the reference object set includes one of the following:
First mode: replacing the candidate virtual objects in the target object set with the candidate virtual objects in the reference object set; or
Second mode: adding the candidate virtual objects included in the reference object set into the target object set.

Two update modes may be provided. In the first mode, the target object set is directly replaced by the acquired reference object set. In the second mode, the candidate virtual objects in the reference object set are added to the target object set.

The two update modes are described below. Assume that the object level of the candidate virtual objects in the target object set acquired through the target object acquisition control is “1 cost,” with 1 gold coin consumed and five candidate virtual objects included. Further assume that the object level of the candidate virtual objects in the reference object set acquired through the reference object acquisition control is “4 cost,” with 4 gold coins consumed and two candidate virtual objects included.

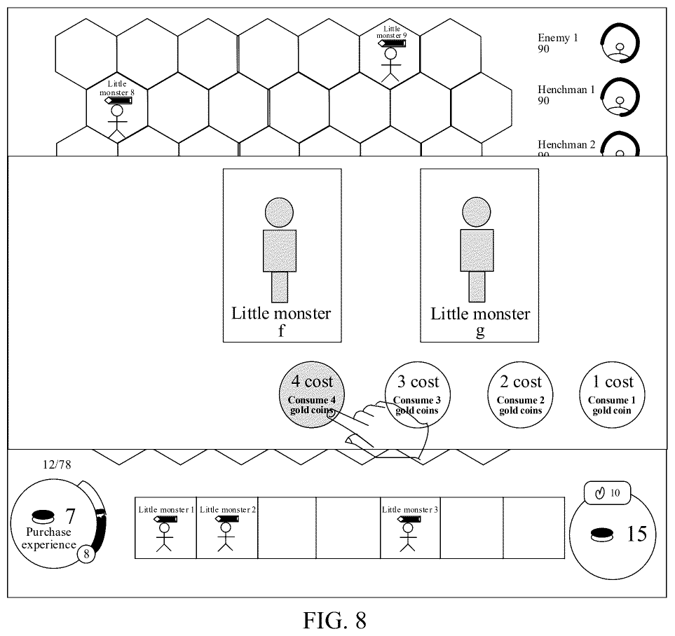

In the first update mode, assume the target account first triggers the target object acquisition control. Five candidate virtual objects with an object level of “1 cost” are acquired by consuming 1 virtual gold coin. When these five candidate virtual objects are displayed, if the target account triggers the reference object acquisition control, the target account consumes 4 virtual gold coins to acquire the reference object set, as shown in FIG. 8. The five “1 cost” candidate virtual objects are simultaneously hidden, and instead, two “4 cost” candidate virtual objects from the reference object set are displayed.

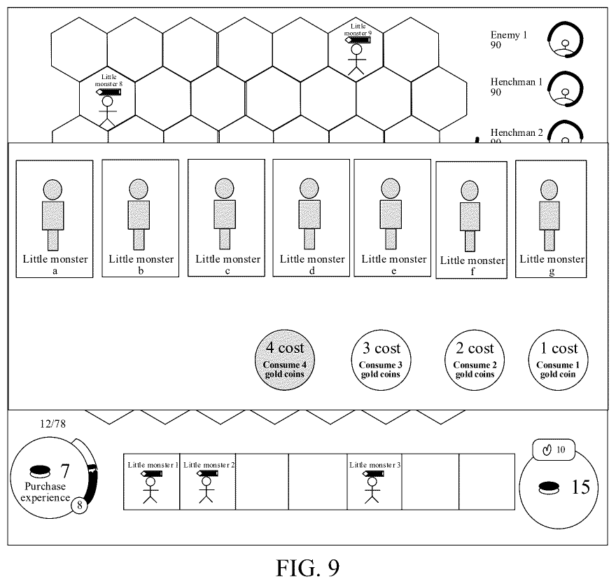

In the second update mode, assume the target account first triggers the target object acquisition control. Five candidate virtual objects with an object level of “1 cost” are acquired by consuming 1 virtual gold coin. When these five candidate virtual objects are displayed, if the target account triggers the reference object acquisition control, the target account consumes 4 virtual gold coins to acquire the reference object set, as shown in FIG. 9. The five “1 cost” candidate virtual objects remain displayed, and two additional “4 cost” candidate virtual objects from the reference object set are displayed. For example, the five “1 cost” and two “4 cost” candidate virtual objects are displayed together.

In some embodiments, the display mode of the candidate virtual objects in the updated target object set may be adjusted according to the quantity of candidate virtual objects. For example, when the quantity is large (e.g., greater than a threshold), the object identifiers of the candidate virtual objects may be zoomed out according to a scaling proportion negatively correlated with the quantity. Alternatively, only part of the candidate virtual objects may be displayed, with a slide control provided so that the remaining candidate virtual objects may be displayed in response to a slide operation. The display mode of the candidate virtual objects is not limited.

In some embodiments, replacing or adding the candidate virtual objects from the reference object set into the target object set provides an update mechanism for the acquired target object set. This increases the probability of acquiring particular virtual objects or combinations of virtual objects for the target account. Adding the candidate virtual objects from the reference object set into the target object set also allows only the newly added objects to be processed, reducing resource use and saving network communication overhead during data transmission.

In some embodiments, acquiring a reference object set corresponding to the reference object acquisition control includes:
First case: acquiring a second quantity of candidate virtual objects as the reference object set when the reference level is higher than the target level, where the second quantity is less than the third quantity of candidate virtual objects included in the target object set before the update; and
Second case: acquiring a fourth quantity of candidate virtual objects as the reference object set when the reference level is less than or equal to the target level, where the fourth quantity is greater than or equal to the fifth quantity of candidate virtual objects included in the target object set before the update.

In some embodiments, for object acquisition controls configured to acquire virtual objects of different object levels, the object quantities of the candidate virtual objects included in the acquired sets may differ. The object levels of the virtual objects may be negatively correlated with their quantities.

As shown in FIG. 6 and FIG. 8, in FIG. 6, the target object acquisition control provides virtual objects at an object level of “1 cost,” with a quantity of five. If the reference object acquisition control “4 cost; consume 4 gold coins” is triggered, additional virtual resources are consumed, for example, reducing the 19 virtual gold coins originally possessed by the target account to 15. At the same time, two candidate virtual objects “little monster f” and “little monster g” acquired from the reference object acquisition control are displayed.

In some embodiments, all virtual objects included in the two sets acquired by sequentially triggering the target object acquisition control and the reference object acquisition control may be displayed together, allowing the target account to select desired target virtual objects.

In some embodiments, during a virtual object acquisition stage of a target turn, the quantity of virtual objects that may be acquired by each object acquisition control is fixed and negatively correlated with the object levels of the virtual objects.

In some embodiments, during the virtual object acquisition stage of the target turn, when an object acquisition control is triggered for the first time, the quantities of the acquired virtual objects are fixed values (e.g., all five). When the target account subsequently triggers the reference object acquisition control, the quantities of the acquired virtual objects are negatively correlated with their object levels.

In some embodiments, when virtual objects of different levels are acquired, the higher the object levels are, the smaller the quantity of acquired virtual objects. If the target account accumulates a large number of virtual resources, this prevents the account from acquiring combinations composed solely of high-level virtual objects, thereby improving task balance in the turn-based task. Adjusting the quantity of virtual objects according to their levels improves processing efficiency.

In some embodiments, acquiring the target object set corresponding to the target object acquisition control includes one of the following:
First mode: acquiring, from a preset first virtual object set and according to the first quantity, candidate virtual objects at the target level, the first virtual object set including multiple virtual objects of different levels, and being shared across accounts in the turn-based virtual task;
Second mode: acquiring, from a second virtual object set possessed by the target account and according to the first quantity, candidate virtual objects at the target level, the second virtual object set including multiple virtual objects configured for the target account before the task starts; or
Third mode: acquiring, from the interaction object set possessed by a reference account and according to the first quantity, candidate virtual objects at the target level, the reference account being configured to perform a card interaction operation with the target account in the turn-based virtual task.

The first quantity is an object quantity corresponding to the target object acquisition control.

Some embodiments provide exemplary acquisition scenes. In the first mode, the target account and other accounts share the first virtual object set. When the target object acquisition control is triggered, the target quantity corresponding to the control and virtual objects at the target level are acquired and displayed.

In the second mode, the second virtual object set may be preconfigured based on the target account. For example, in a card game, the second virtual object set may consist of cards preconfigured by the target account. When the target object acquisition control is triggered, the target quantity and virtual objects at the target level are acquired and displayed.

In the third mode, a new interaction mode is used. The target object set is acquired based on virtual objects possessed by an opponent or teammate account. For example, when the target object acquisition control is triggered, the target quantity and target-level objects are acquired from a teammate's set and an opponent's set. A first quantity of virtual objects is acquired from the teammate's set and a second quantity from the opponent's set, where the sum equals the target quantity.

In some embodiments, the object acquisition method may be applied in multiple scenarios. Candidate virtual objects at a target level may be acquired from the preset first virtual object set, the second virtual object set possessed by the target account, or the interaction object set possessed by the reference account. This diversification improves flexibility in acquiring virtual objects during the turn-based task.

In some embodiments, displaying at least one object acquisition control that matches the account description information includes:
S1: Determine, from a plurality of level intervals and according to the account level of the target account, a target level interval to which the account level belongs, the account description information including the account level, and the account level being updated according to an operation of the target account in the task;
S2: Determine the at least one object acquisition control according to the target level interval, the number of controls being positively correlated with the account level indicated by the interval; and
S3: Display the at least one object acquisition control, including the target object acquisition control.

In some embodiments, the account description information may be the account level. The number and types of displayed object acquisition controls are related to the account level.

In some embodiments, after displaying, in response to a selection operation on a target virtual object in the target object set, the method further includes:
S1: Determine, from the plurality of level intervals, a reference level interval to which the account level belongs, when the account level of the target account increases from the target level to the reference level during a reference turn; and
S2: Acquire a reference object acquisition control that matches the reference level interval, and updating and displaying the at least one object acquisition control accordingly, the object level of the virtual objects acquired by the reference control being higher than that of the virtual objects in the target object set.

In some embodiments, the account level of the target account may be positively correlated with both the number of displayed object acquisition controls and the object levels of the virtual objects that may be acquired by those controls.

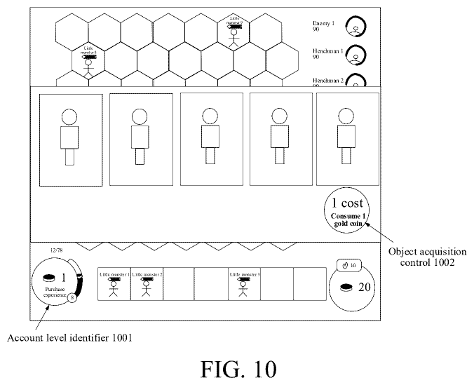

As shown in FIG. 10, according to the indication information of an account level identifier 1001, when the account level of the target account is level 1, the number of correspondingly displayed object acquisition controls is 1, and the displayed object acquisition control 1002 may acquire a virtual object having an object level of “1 cost.” By comparison with FIG. 4, when the account level of the target account is level 7, the number of correspondingly displayed object acquisition controls is 4, and the displayed controls include controls for acquiring virtual objects up to a highest object level of “4 cost.”

In some embodiments, when the account level of the target account increases from the target level to the reference level during a reference turn that matches the target account in the turn-based virtual task, a reference level interval to which the account level belongs is determined from a plurality of level intervals; a reference object acquisition control that matches the reference level interval is then obtained; and the at least one object acquisition control is updated and displayed according to the reference object acquisition control. As the account level of the target account continues to increase, new object acquisition controls capable of acquiring higher-level virtual objects may be activated and displayed, enabling the target account to select different strategies for acquiring and combining virtual objects. Object acquisition controls of corresponding levels are enabled according to the account level to ensure that higher-level virtual objects are not available when the account level is low, thereby maintaining balance between different accounts.

Because a high-level object acquisition control may consume more virtual resources to activate, the target account may choose, in an early stage of a task, to consume fewer virtual resources and quickly obtain a large number of low-level virtual objects to form a first virtual object combination. The target account may alternatively choose to conserve virtual resources in the early stage and accumulate them for a later stage of the task; for example, when the account level is high, a high-level object acquisition control may be activated to acquire high-level virtual objects and thereby form a second virtual object combination. In some embodiments, the object acquisition controls displayed may be determined according to account description information indicating the task progress of the target account in the virtual task, so that different object acquisition controls are displayed at different stages. This allows a user to acquire virtual objects having different attributes at different stages, thereby improving the flexibility of combining virtual objects.

In some embodiments, when the account level of the target account increases from the target level to the reference level during a reference turn, a reference level interval to which the account level belongs is determined from a plurality of level intervals; a reference object acquisition control that matches the reference level interval is obtained; and the at least one object acquisition control is updated and displayed accordingly. As the account level increases, new object acquisition controls for higher-level virtual objects may be continually activated and displayed, enabling the target account to select different strategies for acquiring and combining virtual objects.

In some embodiments, after displaying, in response to a selection operation on a target virtual object in the target object set, the target virtual object in a target region, the method further includes increasing an object interaction parameter of first interaction virtual objects when a number of first interaction virtual objects displayed in the target region is greater than or equal to a target quantity. The object interaction parameter indicates the operational strength of the first interaction virtual objects in performing an interaction operation, and the first interaction virtual objects are virtual objects of a target category.

In some embodiments, possessing a particular number of interaction virtual objects of the same type increases an object parameter of those interaction virtual objects. For example, a particular gain processing may be performed on a designated number of same-type interaction virtual objects possessed by the target account.

The gain processing may include, but is not limited to, increasing the object level of the first interaction virtual objects, enhancing a virtual skill of the first interaction virtual objects, or increasing object attribute data of the first interaction virtual objects.

The object parameter may be embodied as a virtual synergy skill that acts on same-type interaction virtual objects possessed by the target account. For example, when the virtual synergy skill is “enhance armor,” the armor of multiple warrior-type interaction virtual objects is enhanced when the number of warrior-type interaction virtual objects possessed by the target account is greater than or equal to three (e.g., the target quantity). As another example, when the virtual synergy skill is “increase damage,” the damage that multiple assassin-type interaction virtual objects can inflict on enemy virtual objects is increased when the number of assassin-type interaction virtual objects possessed by the target account is greater than or equal to three.

In some embodiments, a gain effect may be preset on a server or may be user-defined. When the number of first interaction virtual objects displayed in the target region equals the target quantity, those first interaction virtual objects may be fused to obtain a second interaction virtual object. The second interaction virtual object has an increased object interaction parameter and, for example, carries the gain effect.

In some embodiments, fusing the target quantity of first interaction virtual objects into the second interaction virtual object allows the gain effect of multiple same-type first interaction virtual objects to be represented by a single second interaction virtual object. This reduces memory usage, shortens server determination time for the virtual objects possessed by the target account, and improves interaction efficiency.

In some embodiments, displaying, in response to a trigger operation on a target object acquisition control among the at least one object acquisition control, a target object set acquired according to the target object acquisition control includes:
S1: Highlight a target virtual object in the target object set when the target object set includes a target virtual object that belongs to the target category; and
S2: Display target prompt information when the target object set does not include a virtual object that belongs to the target category, the target prompt information indicating that the target object set may be updated by consuming virtual resources; and, in response to a confirmation operation on the target prompt information, consuming a target quantity of virtual resources from the virtual resource set currently possessed by the target account and updating the target object set.

In some embodiments, when the candidate virtual objects in the target object set are displayed, those candidate virtual objects that may form a particular object combination are highlighted, thereby prompting the target account that the highlighted candidate virtual objects may be acquired to obtain a particular virtual object combination.

When the displayed candidate virtual objects in the target object set do not include virtual objects that may form the particular object combination, target prompt information may be displayed. The target prompt information may be presented as text and/or images to indicate that the target object set can be updated by further consuming virtual resources, thereby increasing the probability of acquiring a particular type of candidate virtual object and a particular virtual object combination. In this implementation, in response to the target account's confirmation operation on the target prompt information, an update operation on the target object set may be triggered, thereby improving update efficiency.

In some embodiments, the target virtual object is highlighted in the target object set when the set includes a target virtual object that belongs to the target category, and the target prompt information is displayed when the set does not include such a virtual object. When candidate virtual objects are displayed, related information is prompted based on a particular type of virtual object currently required by the target account or a particular virtual object combination to be acquired by the target account, thereby improving the efficiency of acquiring a particular virtual object combination.

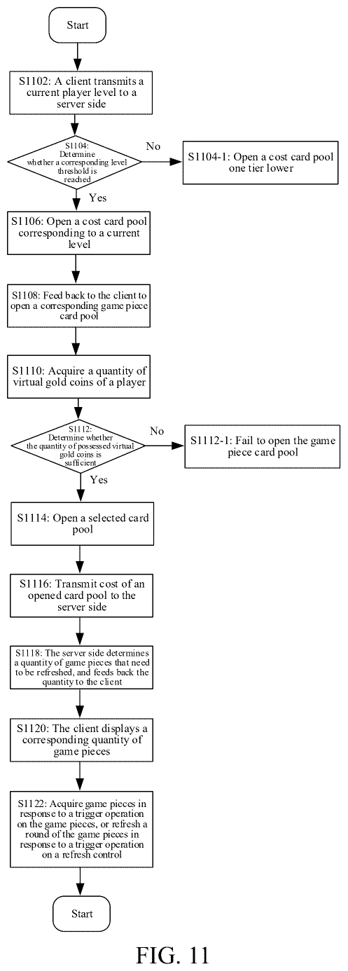

A complete implementation of this application is described below with reference to FIG. 11. In some embodiments, the target account is an object account controlled by a game player, and the virtual object is a virtual game piece in an auto battler game.

Before the auto battler game starts, a server side (e.g., server 106 in FIG. 1) establishes an association mechanism between game piece levels and resources. For example, level 1 unlocks 1-cost game pieces (consuming 1 virtual gold coin); levels 2-3 unlock 2-cost game pieces (consuming 2 virtual gold coins); levels 4-5 unlock 3-cost game pieces (consuming 3 virtual gold coins); levels 6-7 unlock 4-cost game pieces (consuming 4 virtual gold coins); and levels 8-9 unlock 5-cost game pieces (consuming 5 virtual gold coins).
S1102: A client transmits a current player level to the server side.
S1104: The server side determines whether a corresponding level threshold is reached. If the threshold is reached, then S1106 is performed: open a cost card pool corresponding to the current level. If the threshold is not reached, then S1104-1 is performed: open a cost card pool one tier lower, and end.
S1108: The server side feeds back to the client an instruction to open the corresponding game piece card pool.

In this process, the client transmits the current player level to the server side; the server side identifies the level to determine the cost tier of a card pool unlockable at that level; and the server side returns information enabling the client to unlock the corresponding cost card pool.

Correspondingly, as shown on the client in FIG. 4, in an object acquisition stage, after a player enters a virtual store via the resource prompt identifier 403, the store displays the currently available card pool. The system identifies that the current level is level 7 and correspondingly unlocks and displays the game piece card pools of 1 cost, 2 cost, 3 cost, and 4 cost; for example, corresponding object acquisition controls are displayed in an object acquisition region 404.
S1110 (client): Acquire the player's quantity of virtual gold coins.
S1112: Determine whether the quantity of possessed virtual gold coins is sufficient. If not sufficient, S1112-1: fail to open the game piece card pool. If sufficient, S1114: open the selected card pool.

In these operations, the player clicks the corresponding cost card pool to attempt unlocking. The client determines whether the player possesses sufficient virtual gold coins. If sufficient, the cost card pool store is successfully opened and a round of random game pieces at the corresponding cost is refreshed; “sufficient” indicates that the number of possessed virtual gold coins is greater than a threshold. If insufficient, the card pool for that round cannot be opened; “insufficient” indicates that the number of possessed virtual gold coins is less than the threshold.
S1116 (client): Transmit the cost of the opened card pool to the server side.
S1118 (server): Determine the number of game pieces to refresh, and feed back the number to the client.
S1120 (client): Display the corresponding number of game pieces.

In these operations, when the store is opened, the client transmits the cost of the currently opened store to the server side; the server side determines a number of refreshed game pieces corresponding to the current store card cost, refreshes that number of random game pieces, and feeds them back to the client; the client then displays the refreshed game pieces.

As shown in FIG. 5, in response to a trigger operation on object acquisition control 505, the player may consume 1 virtual gold coin and click a 1-cost game piece card pool (e.g., object acquisition control 505) to open a store. The opened store refreshes five 1-cost game piece cards, and the player may select any one card for acquisition.
S1122: Acquire a game piece in response to a trigger operation on the game piece, or refresh a round of game pieces in response to a trigger operation on a refresh control.

In this operation, the player may click any game piece for acquisition. The client determines the game piece selected by the player and adds it to a battle preparation region. After addition, this round of the store ends. The player may also consume virtual gold coins to refresh the content of the current round. The client determines whether the player has sufficient gold coins to refresh. If sufficient, the cost card pool store is successfully refreshed and a new round of random game pieces at the corresponding cost is refreshed. If insufficient, the store for this round may not be refreshed.

As shown in FIG. 6, in response to a selection operation on “little monster e,” “little monster e” may be added into a battle preparation region (e.g., display region 602) for display. After the player selects a game piece, this round of the store is closed and returns to a default state; for example, the display interface is restored to that shown in FIG. 3.

As shown in FIG. 8, in response to a further trigger operation on an object acquisition control, the game pieces in the current round of the store may be refreshed. For example, when an object acquisition control of “4 cost” is triggered, two new candidate virtual objects are refreshed and displayed.

In the above implementation, the player may consume virtual gold coins to upgrade an account level and unlock additional cost card pools after the upgrade. For example, level 1 unlocks 1-cost game piece card pools; levels 2-3 unlock 2-cost game piece card pools; levels 4-5 unlock 3-cost game piece card pools; levels 6-7 unlock 4-cost game piece card pools; and levels 8-9 unlock 5-cost game piece card pools. If the player upgrades to level 7, the player may unlock the 4-cost game piece card pools, consume four virtual gold coins to open a round of the 4-cost card pool, or consume four more gold coins to refresh that round. The higher the opening cost of the card pool, the fewer the game pieces in the pool, thereby preventing a player from quickly acquiring a high-cost three-star game piece and causing imbalance.

Some embodiments provide an acquisition method for a virtual object. By unlocking exclusive cost-tier game piece stores corresponding to different levels, a player may rapidly form a low-cost deck or, alternatively, accumulate gold coins to upgrade to a high level and quickly acquire powerful high-cost cards, thereby enriching the gameplay of the auto battler.

For simplicity of description, the above method embodiments are presented as a series of action combinations. It should be understood that this application is not limited by the sequence of the described actions, as some operations may be performed in another sequence or simultaneously. It should also be understood that the embodiments described herein are examples.

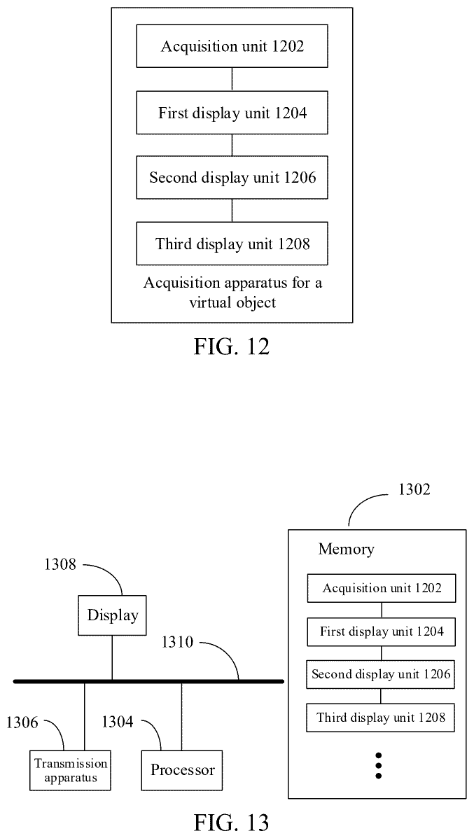

According to another aspect of some embodiments, an acquisition apparatus for a virtual object for implementing the foregoing method is provided. As shown in FIG. 12, the apparatus includes:
an acquisition unit 1202, configured to acquire, in a target turn that matches a target account in a turn-based virtual task, account description information of the target account, the account description information being configured to indicate task progress of the target account in the turn-based virtual task;
a first display unit 1204, configured to display at least one object acquisition control that matches the account description information, the object acquisition control being configured to acquire a virtual object set that includes at least one virtual object having the same object attribute;
a second display unit 1206, configured to display, in response to a trigger operation on a target object acquisition control among the at least one object acquisition control, a target object set acquired according to the target object acquisition control; and
a third display unit 1208, configured to display, in response to a selection operation on a target virtual object in the target object set, the target virtual object in a target region, the target region being configured to display an interaction object set currently possessed by the target account, wherein interaction virtual objects in the interaction object set are configured to perform an interaction operation in a virtual scene.

In some embodiments, the second display unit 1206 includes: a consumption module, configured to consume, in response to the trigger operation on the target object acquisition control, a target quantity of virtual resources from a virtual resource set currently possessed by the target account when target resource indication information is displayed on the target object acquisition control, each object acquisition control displaying resource indication information that indicates virtual resources to be consumed for acquiring a corresponding virtual object set; an acquisition module, configured to acquire the target object set corresponding to the target object acquisition control, wherein the virtual objects in the virtual object set corresponding to one object acquisition control have the same object level, an object level of candidate virtual objects in the target object set is a target level, and an object attribute includes the object level; and a display module, configured to display the candidate virtual objects included in the target object set.

In some embodiments, the second display unit 1206 is further configured to: display a first object acquisition control according to a target style when a quantity of virtual resources currently possessed by the target account is less than a first quantity indicated by first resource indication information, the first resource indication information being displayed on the first object acquisition control; and display operation prompt information, in response to a trigger operation on the first object acquisition control, indicating that the virtual object set corresponding to the first object acquisition control may not currently be acquired.

In some embodiments, the display module is further configured to: consume, in response to a trigger operation on a reference object acquisition control, a reference quantity of virtual resources from the virtual resource set currently possessed by the target account; acquire a reference object set corresponding to the reference object acquisition control, wherein an object level of candidate virtual objects in the reference object set is a reference level; update the target object set according to the reference object set; and display the candidate virtual objects included in the updated target object set.

In some embodiments, the acquisition module is further configured to: acquire a second quantity of candidate virtual objects as the reference object set when the reference level is higher than the target level, the second quantity being less than a third quantity of candidate virtual objects included in the target object set before the update; and acquire a fourth quantity of candidate virtual objects as the reference object set when the reference level is less than or equal to the target level, the fourth quantity being greater than or equal to a fifth quantity of candidate virtual objects included in the target object set before the update.

In some embodiments, the acquisition module is further configured to perform one of the following: replace the candidate virtual objects in the target object set with the candidate virtual objects in the reference object set; or add the candidate virtual objects included in the reference object set into the target object set.

In some embodiments, the acquisition module is further configured to perform one of the following: acquire, from a preset first virtual object set and according to a first quantity, candidate virtual objects having the object level equal to the target level as the target object set, the first virtual object set including a plurality of virtual objects having different object levels and being configured to provide virtual objects for different object accounts in the turn-based virtual task; acquire, from a second virtual object set possessed by the target account and according to the first quantity, candidate virtual objects having the object level equal to the target level as the target object set, the second virtual object set including a plurality of virtual objects configured for the target account before the turn-based virtual task starts; or acquire, from an interaction object set possessed by a reference account and according to the first quantity, candidate virtual objects having the object level equal to the target level as the target object set, the reference account being configured to perform a card interaction operation with the target account in the turn-based virtual task; wherein the first quantity is an object quantity corresponding to the target object acquisition control.

In some embodiments, the first display unit 1204 includes: a first determination module, configured to determine, from a plurality of level intervals and according to an account level of the target account, a target level interval to which the account level belongs, the account description information including the account level, and the account level being updated according to an operation of the target account in the turn-based virtual task; a second determination module, configured to determine the at least one object acquisition control according to the target level interval, a number of object acquisition controls being positively correlated with the account level indicated by the level interval; and a first display module, configured to display the at least one object acquisition control, the at least one object acquisition control including the target object acquisition control.

In some embodiments, the acquisition apparatus for a virtual object further includes an update unit configured to determine, from a plurality of level intervals, a reference level interval to which the account level belongs when the account level of the target account increases from a target level to a reference level during a reference turn that matches the target account in the turn-based virtual task. The update unit is further configured to obtain a reference object acquisition control that matches the reference level interval and to update and display the at least one object acquisition control according to the reference object acquisition control, where the object level of the virtual objects acquired by the reference object acquisition control is higher than the object level of the virtual objects in the target object set.

In some embodiments, the acquisition apparatus for a virtual object further includes an increasing unit configured to increase an object interaction parameter of first interaction virtual objects when the number of first interaction virtual objects displayed in the target region is greater than or equal to a target quantity. The object interaction parameter indicates the operational strength of the first interaction virtual objects in performing the interaction operation, and the first interaction virtual objects are virtual objects of a target category.

In some embodiments, the third display unit 1208 is configured to highlight a target virtual object in the target object set when the target object set includes a target virtual object that belongs to the target category, and to display target prompt information when the target object set does not include a virtual object that belongs to the target category. The target prompt information indicates that the target object set may be updated by consuming virtual resources. In response to a confirmation operation on the target prompt information, the third display unit 1208 consumes a target quantity of virtual resources from the virtual resource set currently possessed by the target account and updates the target object set.

In some embodiments, the implementations performed by the foregoing unit modules may refer to the method embodiments described above and are not repeated here.

According to another aspect, an electronic device for implementing the acquisition method for a virtual object is provided. The electronic device may be a terminal device or a server as shown in FIG. 13. In some embodiments, the electronic device is a terminal device. As shown in FIG. 13, the electronic device includes a memory 1302 and a processor 1304. The memory 1302 stores a computer program, and the processor 1304 is configured to perform operations of any method embodiment by executing the computer program.

In some embodiments, the electronic device may be located in at least one network device among a plurality of network devices in a computer network.

In some embodiments, the processor is configured to perform the following operations through the computer program:
S1: Acquire, in a target turn that matches a target account in a turn-based virtual task, account description information of the target account, the account description information being configured to indicate task progress of the target account in the turn-based virtual task;
S2: Display at least one object acquisition control that matches the account description information, the object acquisition control being configured to acquire a virtual object set that includes at least one virtual object having the same object attribute;
S3: Display, in response to a trigger operation on a target object acquisition control among the at least one object acquisition control, a target object set acquired according to the target object acquisition control; and
S4: Display, in response to a selection operation on a target virtual object in the target object set, the target virtual object in a target region, the target region being configured to display an interaction object set currently possessed by the target account, where interaction virtual objects in the interaction object set are configured to perform an interaction operation in a virtual scene.

For a person of ordinary skill in the art, the structure shown in FIG. 13 is exemplary. The electronic apparatus or electronic device may be a terminal device such as a smartphone (e.g., an Android or iOS phone), a tablet computer, a palmtop computer, a mobile Internet device (MID), or a portable Apple device (PAD). FIG. 13 does not limit the structures of the electronic apparatus or electronic device. For example, the device may include more or fewer components (e.g., a network interface) than those shown in FIG. 13 or may have a configuration different from that shown in FIG. 13.

The memory 1302 may store software programs and modules, such as program instructions/modules corresponding to the acquisition method and apparatus for a virtual object. The processor 1304 executes the software programs and modules stored in the memory 1302 to perform various function applications and data processing, for example, to implement the acquisition method for a virtual object. The memory 1302 may include high-speed random access memory and/or non-volatile memory, such as one or more magnetic storage devices, flash memory, or other non-volatile solid-state memory. In some embodiments, the memory 1302 may further include memories remotely located relative to the processor 1304 and connected to the terminal through a network. Examples of the network include, but are not limited to, the Internet, an intranet, a local area network, a mobile communication network, and combinations thereof. The memory 1302 may be configured to store information such as acquisition information of various elements and virtual objects in a scene. For example, as shown in FIG. 13, the memory 1302 may store, without limitation, logic corresponding to the acquisition unit 1202, the first display unit 1204, the second display unit 1206, and the third display unit 1208 of the acquisition apparatus for a virtual object, as well as other module units of the apparatus.

In some embodiments, a transmission apparatus 1306 is configured to receive or transmit data through a network. The network may be wired and/or wireless. In one example, the transmission apparatus 1306 includes a network interface controller (NIC) connected to other network devices and routers through a network cable to communicate with the Internet or a local area network. In another example, the transmission apparatus 1306 is a radio frequency (RF) module configured to communicate wirelessly with the Internet.

The electronic device further includes a display 1308 configured to display a virtual scene in a display interface, and a connection bus 1310 configured to connect various modular components in the electronic device.

In some embodiments, the terminal device or server may be a node in a distributed system, such as a blockchain system. The blockchain system may be a distributed system formed by a plurality of nodes connected via network communication, where a peer-to-peer network is formed among the nodes. Any computing device (e.g., a server, a terminal, or another electronic device) may become a node in the blockchain system by joining the peer-to-peer network.

According to another aspect, a computer program product is provided, including computer programs/instructions with program code configured to perform the methods shown in the flowcharts. In some embodiments, the computer programs may be downloaded and installed from a network through a communication component and/or installed from a removable medium. When the computer programs are executed by a central processing unit, various functions provided in some embodiments are performed.

The sequence numbers of some embodiments are for descriptive purposes only and do not imply preference among embodiments.

According to another aspect, a computer-readable storage medium is provided. A processor of a computer device reads computer instructions from the computer-readable storage medium and executes the computer instructions to cause the computer device to perform the acquisition method for a virtual object.

In some embodiments, the computer-readable storage medium may store computer programs for executing the following operations:
S1: Acquire, in a target turn that matches a target account in a turn-based virtual task, account description information of the target account, the account description information being configured to indicate task progress of the target account in the turn-based virtual task;
S2: Display at least one object acquisition control that matches the account description information, the object acquisition control being configured to acquire a virtual object set that includes at least one virtual object having the same object attribute;
S3: Display, in response to a trigger operation on a target object acquisition control among the at least one object acquisition control, a target object set acquired according to the target object acquisition control; and
S4: Display, in response to a selection operation on a target virtual object in the target object set, the target virtual object in a target region, the target region being configured to display an interaction object set currently possessed by the target account, where interaction virtual objects in the interaction object set are configured to perform an interaction operation in a virtual scene.

In some embodiments, for a person of ordinary skill in the art, all or some operations in the various methods described above may be completed by programs that instruct relevant hardware of a terminal device. The programs may be stored in a computer-readable storage medium. The storage medium may include a flash drive, read-only memory (ROM), random access memory (RAM), a magnetic disk, an optical disc, or the like.

When implemented as a software functional unit and sold or used as an independent product, an integrated unit in the above embodiment may be stored in a computer-readable storage medium. Based on this understanding, some embodiments may be reflected, in whole or in part, as a software product constituting a contribution to the related art. A computer software product stored in a storage medium includes a plurality of instructions that enable one or more computer devices (e.g., a personal computer, a server, or a network device) to execute all or some operations of the methods in some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for acquiring a virtual object, performed by an electronic device, the method comprising:
acquiring, in a target turn of a turn-based virtual task, account description information of a target account, the account description information indicating task progress of the target account in the turn-based virtual task;
displaying at least one object acquisition control that corresponds to the account description information, wherein an object acquisition control is for acquiring a virtual object set that comprises at least one virtual object having a common object attribute;
displaying, in response to a trigger operation on a target object acquisition control of the at least one object acquisition control, a target object set acquired based on the target object acquisition control; and
displaying, in response to a selection operation on a target virtual object in the target object set, the target virtual object in a target region for displaying an interaction object set currently possessed by the target account, wherein interaction virtual objects in the interaction object set are for performing an interaction operation in a virtual scene.

2. The method according to claim 1, wherein the displaying the target object set comprises:
consuming, in response to the trigger operation on the target object acquisition control, a target quantity of virtual resources from a virtual resource set of the target account when target resource indication information is displayed on the target object acquisition control, the target resource indication information indicating the virtual resources required to acquire a corresponding virtual object set;
acquiring the target object set corresponding to the target object acquisition control, wherein candidate virtual objects in the target object set are at a target level and the common object attribute comprises an object level; and
displaying the candidate virtual objects in the target object set.

3. The method according to claim 2, wherein the displaying the at least one object acquisition control comprises:
displaying a first object acquisition control in a target style based on a quantity of the virtual resources of the target account being less than a first quantity indicated by first resource indication information displayed on the first object acquisition control; and
displaying, in response to a trigger operation on the first object acquisition control, operation prompt information indicating that the virtual object set corresponding to the first object acquisition control is not available for acquisition.

4. The method according to claim 2, further comprising, after displaying the target object set:
consuming, in response to a trigger operation on a reference object acquisition control, a reference quantity of virtual resources from the virtual resource set of the target account;
acquiring a reference object set corresponding to the reference object acquisition control, wherein candidate virtual objects in the reference object set are at a reference level;
updating the target object set based on the reference object set to generate an updated target object set; and
displaying the candidate virtual objects in the updated target object set.

5. The method according to claim 4, wherein the acquiring the reference object set comprises:
acquiring a second quantity of candidate virtual objects as the reference object set based on the reference level being higher than the target level, the second quantity being less than a third quantity of the candidate virtual objects in the target object set before the update; and
acquiring a fourth quantity of candidate virtual objects as the reference object set based on the reference level being less than or equal to the target level, the fourth quantity being greater than or equal to a fifth quantity of the candidate virtual objects in the target object set before the update.

6. The method according to claim 4, wherein the updating the target object set comprises:
replacing the candidate virtual objects in the target object set with the candidate virtual objects in the reference object set; or
adding the candidate virtual objects in the reference object set to the target object set.

7. The method according to claim 4, wherein the displaying the candidate virtual objects in the updated target object set comprises:
zooming out identifiers of the candidate virtual objects according to a scaling proportion negatively correlated with a quantity of the candidate virtual objects based on the quantity exceeding a threshold; or
displaying a portion of the candidate virtual objects and providing a slide control based on the quantity exceeding the threshold, wherein remaining candidate virtual objects are displayed based on a slide operation performed on the slide control.

8. The method of claim 2, wherein acquiring the target object set comprises:
acquiring, from a preset first virtual object set shared by different object accounts, a first quantity of candidate virtual objects at the target level to form the target object set;
acquiring, from a second virtual object set possessed by the target account, the first quantity of candidate virtual objects at the target level to form the target object set; or
acquiring, from an interaction object set possessed by a reference account, the first quantity of candidate virtual objects at the target level to form the target object set,
wherein the first quantity is an object quantity corresponding to the target object acquisition control.

9. The method according to claim 2, wherein the displaying the at least one object acquisition control comprises:
determining, from a plurality of level intervals and based on an account level of the target account, a target level interval to which the account level belongs, wherein the account description information comprises the account level, and the account level is updated based on operations of the target account in the turn-based virtual task;
determining the at least one object acquisition control based on the target level interval, wherein a number of the at least one object acquisition control is positively correlated with the account level; and
displaying the at least one object acquisition control.

10. The method according to claim 9, further comprising:
determining, from the plurality of level intervals, a reference level interval to which the account level belongs based on the account level of the target account increasing to a reference level in a reference turn; and
acquiring a reference object acquisition control that matches the reference level interval and updating the display of the at least one object acquisition control according to the reference object acquisition control, wherein an object level of virtual objects acquired by the reference object acquisition control is higher than an object level of the candidate virtual objects in the target object set.

11. An acquisition apparatus for a virtual object, comprising:
at least one memory configured to store computer program code; and
at least one processor configured to read the program code and operate as instructed by the program code, the program code comprising:
acquisition code configured to cause at least one of the at least one processor to acquire, in a target turn of a turn-based virtual task, account description information of a target account, the account description information indicating task progress of the target account in the turn-based virtual task;
first display code configured to cause at least one of the at least one processor to display at least one object acquisition control that corresponds to the account description information, wherein an object acquisition control is for acquiring a virtual object set that comprises at least one virtual object having a common object attribute;
second display code configured to cause at least one of the at least one processor to display, in response to a trigger operation on a target object acquisition control of the at least one object acquisition control, a target object set acquired based on the target object acquisition control; and
third display code configured to cause at least one of the at least one processor to display, in response to a selection operation on a target virtual object in the target object set, the target virtual object in a target region for displaying an interaction object set currently possessed by the target account, wherein interaction virtual objects in the interaction object set are for performing an interaction operation in a virtual scene.

12. The apparatus according to claim 11, wherein the second display code is configured to cause at least one of the at least one processor to:
consume, in response to the trigger operation on the target object acquisition control, a target quantity of virtual resources from a virtual resource set of the target account when target resource indication information is displayed on the target object acquisition control, the target resource indication information indicating the virtual resources required to acquire a corresponding virtual object set;
acquire the target object set corresponding to the target object acquisition control, wherein candidate virtual objects in the target object set are at a target level and the common object attribute comprises an object level; and
display the candidate virtual objects in the target object set.

13. The apparatus according to claim 12, wherein the first display code is configured to cause at least one of the at least one processor to:
display a first object acquisition control in a target style based on a quantity of the virtual resources of the target account being less than a first quantity indicated by first resource indication information displayed on the first object acquisition control; and
display, in response to a trigger operation on the first object acquisition control, operation prompt information indicating that the virtual object set corresponding to the first object acquisition control is not available for acquisition.

14. The apparatus according to claim 12, wherein the program code further comprises reference acquisition code configured to cause at least one of the at least one processor to, after displaying the target object set:
consume, in response to a trigger operation on a reference object acquisition control, a reference quantity of virtual resources from the virtual resource set of the target account;
acquire a reference object set corresponding to the reference object acquisition control, wherein candidate virtual objects in the reference object set are at a reference level;
update the target object set based on the reference object set to generate an updated target object set; and
display the candidate virtual objects in the updated target object set.

15. The apparatus according to claim 14, wherein the reference acquisition code is configured to cause at least one of the at least one processor to:
acquire a second quantity of candidate virtual objects as the reference object set based on the reference level being higher than the target level, the second quantity being less than a third quantity of the candidate virtual objects in the target object set before the update; and
acquire a fourth quantity of candidate virtual objects as the reference object set based on the reference level being less than or equal to the target level, the fourth quantity being greater than or equal to a fifth quantity of the candidate virtual objects in the target object set before the update.

16. The apparatus according to claim 14, wherein the reference acquisition code is configured to cause at least one of the at least one processor to:
replace the candidate virtual objects in the target object set with the candidate virtual objects in the reference object set; or
add the candidate virtual objects in the reference object set to the target object set.

17. The apparatus according to claim 14, wherein the reference acquisition code is configured to cause at least one of the at least one processor to:
zoom out identifiers of the candidate virtual objects according to a scaling proportion negatively correlated with a quantity of the candidate virtual objects based on the quantity exceeding a threshold; or
display a portion of the candidate virtual objects and provide a slide control based on the quantity exceeding the threshold, wherein remaining candidate virtual objects are displayed based on a slide operation performed on the slide control.

18. The apparatus according to claim 12, wherein the second display code is configured to cause at least one of the at least one processor to acquire the target object set by performing:
acquiring, from a preset first virtual object set shared by different object accounts, a first quantity of candidate virtual objects at the target level to form the target object set;
acquiring, from a second virtual object set possessed by the target account, a first quantity of candidate virtual objects at the target level to form the target object set; or
acquiring, from an interaction object set possessed by a reference account, a first quantity of candidate virtual objects at the target level to form the target object set,
wherein the first quantity is an object quantity corresponding to the target object acquisition control.

19. The apparatus according to claim 12, wherein the first display code is configured to cause at least one of the at least one processor to:
determine, from a plurality of level intervals and based on an account level of the target account, a target level interval to which the account level belongs, wherein the account description information comprises the account level, and the account level is updated based on operations of the target account in the turn-based virtual task;
determine the at least one object acquisition control based on the target level interval, wherein a number of the at least one object acquisition control is positively correlated with the account level; and
display the at least one object acquisition control.

20. A non-transitory computer-readable storage medium, storing computer code which, when executed by at least one processor, causes the at least one processor to at least:
acquire, in a target turn of a turn-based virtual task, account description information of a target account, the account description information indicating task progress of the target account in the turn-based virtual task;
display at least one object acquisition control that corresponds to the account description information, wherein an object acquisition control is for acquiring a virtual object set that comprises at least one virtual object having a common object attribute;
display, in response to a trigger operation on a target object acquisition control of the at least one object acquisition control, a target object set acquired based on the target object acquisition control; and
display, in response to a selection operation on a target virtual object in the target object set, the target virtual object in a target region for displaying an interaction object set currently possessed by the target account, wherein interaction virtual objects in the interaction object set are for performing an interaction operation in a virtual scene.
